(19) United States
(12) Patent Application Publication
(10) Pub. No.: US 2005/0283793 A1
(43) Pub. Date: Dec. 22, 2005

(54) Advertising detection method and related system for detecting advertising according to specific beginning/ending images of advertising sections

(76) Inventor: Andy Chiu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/711,341

(22) Filed: Sep. 12, 2004

(30) Foreign Application Priority Data
Jun. 18, 2004 (TW) 093117819

(51) Int. Cl. H04H 9/00; H04N 7/16; H04N 7/025; H04N 7/10

(52) U.S. Cl. 725/19; 725/32

(57) ABSTRACT

A method and related system for detecting insertion points of advertising sections within a video signal. When broadcasting media provide program services, frames of specific images are inserted before or after an advertising section to indicate beginnings or endings of the advertising sections. The present invention is capable of learning/storing specific images assigned by users. When the present invention performs advertising detection of a video signal, the invention is capable of comparing stored images and frames within the video signal, such that the insertion points, which indicate beginnings or endings of advertising sections, can be detected.

### BACKGROUND OF INVENTION

1. Field of the Invention

The present invention relates to a method and related system for detecting an advertising section within a video signal, and more particularly, to a method and related system capable of learning/storing the beginning/ending images of advertising sections for detecting advertising sections.

2. Description of the Prior Art

In our modern information society, audiences receive useful knowledge, news, information, or fun video entertainment from program services provided by broadcasting media through cables or wirelessly. However, regarding commercial cost, advertising sections are inserted among normal programs provided by broadcasting media. Such advertising sections not only interrupt the continuity of the programs, but also disturb the audience in enjoying the programs. If a user records programs for future reference or to watch the programs later, these advertising sections waste recording resources and time. Additionally, the user cannot search, manage or access the recorded video signals rapidly.

### SUMMARY OF INVENTION

It is therefore a primary objective of the claimed invention to provide a method and related system for detecting an advertising section within a video signal to solve the above-mentioned problems. The claimed invention detects insertion points of the beginning/ending of advertising sections within a recorded video signal so as to assist the user in disregarding or filtering advertising sections.

Generally, when broadcasting media provide program services, frames of specific images are inserted before or after an advertising section. For instance, such frames of specific images may indicate the logo of a broadcasting station, alert the audience to an oncoming advertising section, or indicate that a normal program begins when the advertising section ends. Frames of specific images used in different advertising sections are the same and have the same content. Therefore, the claimed invention utilizes this property to detect the insertion points of advertising sections. The claimed invention is capable of learning and storing such frames of specific images in advance, and recording such frames as reference frames. When the claimed invention performs advertising detection of a video signal, the claimed invention compares the stored reference frames with frames of the video signal to detect the insertion points of the beginnings or endings of the advertising section. The claimed invention can assist the user in disregarding, skipping or filtering advertising sections.

The claimed invention is implemented with a display (such as a TV screen). The display is capable of displaying broadcast video programs. On seeing the insertion points of advertising sections, the user can utilize the claimed invention to record frames of specific images as reference frames. Therefore, the claimed invention can perform advertising detection according to the stored reference frames.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 and FIG. 2 are diagrams of video signals with insertion of advertising sections.

FIG. 3 and FIG. 4 are diagrams of different embodiments according to the present invention.

### DETAILED DESCRIPTION

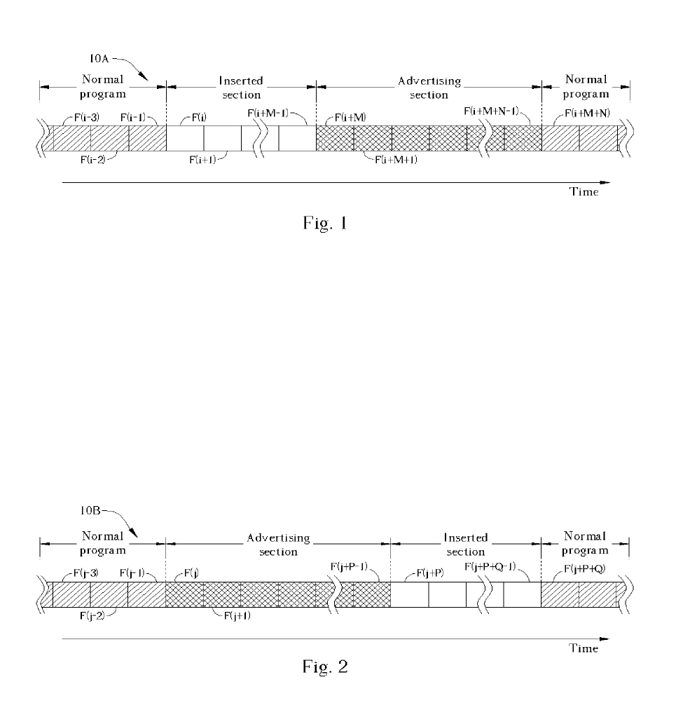

Please refer to FIG. 1 and FIG. 2. FIG. 1 and FIG. 2 are diagrams of video signals 10A and 10B with insertion of advertising sections, respectively. In FIG. 1, the video signal 10A provides frames F(i−3), F(i−2), F(i−1), F(i), . . . F(i+M+N), each frame respectively presenting a static image. The frames F(i−3) to F(i+M+N) in sequence provided by the video signal 10A together display a motion picture (i.e. a video). As mentioned above, when broadcasting media outlets provide programs by video signals, advertising sections are inserted into programs. In the video signal 10A of FIG. 1, frames F(i−3) to F(i−1) and frames after and including F(i+M+N) are frames of a program. In other words, clips of motion picture of a normal program are displayed by these frames. However, frames F(i+M) to F(i+M+N−1) are frames of advertising sections. In addition, broadcasting companies usually use the same frames of specific images to separate normal programs and advertising sections. In the video signal 10A of FIG. 1, an inserted section of specific images is inserted before the beginning of an advertising section. The inserted section includes frames F(i) to F(i+M−1). For instance, the content of the inserted section might present words such as “Take a break” to indicate the interruption of the normal program and the beginning of advertising sections.

Additionally, such frames of specific images might be inserted between the ending of an advertising section and the beginning of a normal program. As shown in the video signal 10B of FIG. 2, frames F(j−3) to F(j−1) and frames after and including F(j+P+Q) are frames of a normal program. Frames F(j) to F(j+P−1) are frames of advertising sections. After the advertising section ends, a section having frames F(j+P) to F(j+P+Q−1) is inserted. For instance, the content of the inserted section might present words such as “Welcome back to the program”, a logo of the broadcasting company, or an animation. Of course, some broadcasting companies insert the same specific frames before and after advertising sections.

Insertion points of advertising sections (beginnings or endings of advertising sections) can be detected by finding frames having specific images since such frames before and after different advertising sections have the same content. Therefore, according to this property, the present invention can automatically detect insertion points of advertising sections from video signals so as to assist the user in disregarding and editing advertising sections. Thus, the user can manage, use and access video signals of a program services more efficiently and easily. When the present invention is implemented, frames of specific images (inserted sections) can be recorded as reference frames in advance. When the present invention performs advertising detection, the present invention compares each frame of the video signal with the stored reference frames. If the content of a certain frame conforms to that of the reference frame or if the similarity of a frame of the video signal and a reference frame is greater than a predetermined similarity, the frame is regarded as the frame of the specific image. Therefore, the insertion point of the advertising section is found.

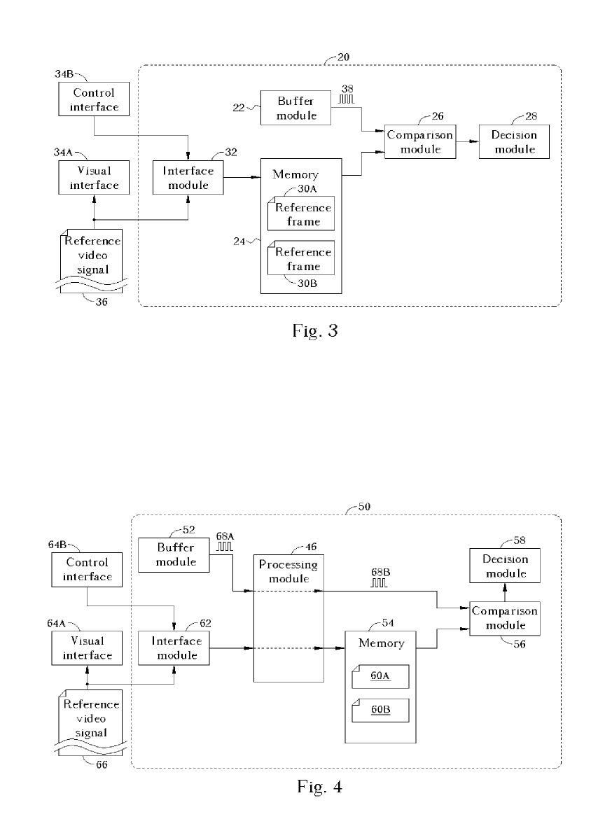

Please refer to FIG. 3. The present invention can be implemented by a signal processing system 20 of FIG. 3. The signal processing system 20 is implemented in a digital video recorder (DVR), a video cassette recorder (VCR), or a multimedia computer, such as a video card of a computer. In FIG. 3, the signal processing system 20 includes a buffer module 22, an interface module 32, a memory 24, a comparison module 26, and a decision module 28. The memory 24 is utilized for storing frames of specific images as reference frames 30A, 30B, etc. In other words, the memory 24 stores one or more reference frames. When the present invention performs advertising detection of a video signal 38, the video signal 38 is temporarily stored in the buffer module 22, and the comparison module 26 compares each frame of the video signal 38 with the reference frames 30A, 30B stored in the memory 24 for similarity. The decision module 28 determines or records insertion points of advertising sections according to the result of the comparison module 26. As mentioned above, if a frame of the video signal 38 conforms to one of the reference frames 30A, 30B, in other words, if the similarity of a frame of the video signal 38 and one of the reference frames 30A, 30B is greater than a predetermined similarity, the decision module 28 regards the frame of the video signal 38 as a frame of the specific image. Therefore, using stored frames having specific images, normal programs and advertising sections are distinguished.

A visual interface 34A and a control interface 34B are implemented with the signal processing system 20 of the present invention for capturing/storing frames of specific images as reference frames. The visual interface 34A broadcasts a reference video signal 36 to the user, and the control interface 34B receives the input from the user. In addition, the signal processing system 20 further has an interface module 32. When the user watches the reference video signal 36 through the visual interface 34A, the user can perform reference frame capture through the control interface 34 if the frames of the specific images appearing before and after advertising sections are displayed on the visual interface 34A. Thus, the interface module 32 captures the frames of specific images from the reference video signal 36 and transmits the frames to the memory 24 and stores these frames as reference frames. Note that the reference video signal 36 can be the same as the video signal 38.

For instance, the signal processing system 20 of the present invention can be embedded in a video recorder and the control interface 34B can be the control interface of the video recorder, such as a remote control. When the user watches the recorded video signal through a TV, the visual interface 34A of FIG. 3 is the TV. The video signal provided by the video recorder is regarded as the reference video signal 36 displayed to the user and regarded as the video signal 38 for simultaneously performing advertising detection. When the user watches the video signal, the user suspends (pause) the display of the video signal if a frame of a specific image appears and the present invention starts capturing the frame of the specific image. In the present invention, a specific button is set on the control interface of the video recorder for triggering reference frame capture. Next, the interface module 32 captures and transmits the frame to the memory 24 recording the frame as a reference frame. After the interface module 32 completes reference frame capture, a specific message is displayed on the visual interface 34A to inform the user that reference frame capture is complete, and then the signal processing system 20 performs advertising detection according to the reference frame to detect the insertion points of advertising sections when the user continues displaying the video signal. For example, the user controls the signal processing system 20 to perform advertising detection of the video signals recorded by the video recorder for detecting the insertion points of advertising sections, and the signal processing system 20 displays the related messages with the visual interface 34A for the insertion points of advertising sections, such as reduced-size images (thumbnails) before and after advertising sections. This assists the user in deleting the advertising section or in disregarding the advertising section when the video recorder is playing.

In the signal processing system 20, the memory 24 can be a non-volatile memory for storing the reference frames assigned by the user and thereby the signal processing system 20 can perform advertising detection of other video signals according to the reference frames stored in the memory 24. Furthermore, when the reference frames are captured, the user can assign the reference frame to the frame before or after the frames of advertising sections and thereby the decision module 28 can determine where advertising sections are. For instance, suppose that the reference frame 30A includes the text “Take a break”, which is shown before advertising sections. When the signal processing system 20 finds a frame of the video signal 38 similar to the reference frame 30A, the decision module 28 can conclude that an advertising section follows. Similarly, suppose that the user selects a frame from the video signal 38. If the signal processing system 20 finds that the selected frame conforms to a reference frame, the decision module 28 displays the reduced-size images before and after the selected frame to the user through the visual interface 34A. Then the user can decide that whether the frame before or after the selected frame belongs to the advertising section and edit, filter or disregard the advertising section.

Also, the present invention can allow users to edit a reference image with the interface module 32 and the control interface 34B. For instance, each reference frame (or related messages, such as time of capturing reference frames, whether reference frames are before or after the advertising section, etc.) stored in the memory 24 is displayed to the user through the visual interface 34A. If a certain reference frame is no more needed by the user, the user can delete that reference frame using the control interface 34B. The present invention also provides reference frames by ways other than the user capturing the reference frame. For instance, a manufacturer providing the signal processing system 20 can embed some common reference frames into the memory 24, or update the reference frames of the memory 24 through a network. For example, the signal processing system 20 of FIG. 3 can be embedded into a multimedia computer that can record video signals onto a hard disc. The manufacturer can capture frames of specific images from different broadcasting companies in advance and store these frames in a network server. Therefore, the user can download these reference frames into their computer through the network for performing advertising detection.

Additionally, the present invention can utilize a predetermined calculation to calculate representation value corresponding to each frame. When performing advertising detection of a video signal, the present invention compares the representation value of each frame of the video signal with the representation value of the reference frame and determines if the representation value of the video signal conforms to that of the reference frame. FIG. 4 shows a signal processing system 50 according to another embodiment of the present invention. The signal processing system 50 is similar to the signal processing system 20 of FIG. 3. The signal processing system 50 for performing advertising detection of a video signal 68A includes a buffer module 52, a memory 54, a comparison module 56, and a decision module 58. The signal processing system 50 further includes an interface module 62 to cooperate with a control interface 64B and a visual interface 64A for capturing a reference frame from a reference video signal 66. In addition, the signal processing system 50 further has a processing module 46 for calculating representation value corresponding to each frame.

The operation of the signal processing system 50 is described as follows. The user can watch the reference signal 66 on the visual interface 64A and capture a reference frame by the control interface 64B and the interface module 62. The reference frame captured by the interface module 62 is transformed into representation value by the processing module 46 and stored in the memory 54. The representation value 60A and 60B correspond to different reference frames. When performing advertising detection of the video signal 68A, each frame of the video signal 68A is transformed into representation value 68B by the processing module 46. The comparison module 56 compares the representation value 68B of the video signal with that of the reference frame to determine if the representation value 68B conforms to that of the reference frame. The decision module 58 detects the insertion points. If representation value of a certain frame of the video signal 68A conforms to that of the reference frame, the decision module 58 regards the certain frame as a frame of the specific image thereby determining the insertion point of the advertising section.

In practical application, the processing module 46 takes information of all pixels of a frame, such as brightness or color, as the representation value corresponding to the frame, or takes a histogram of color or brightness of the frame as the representation value of the frame. Another realization is to obtain frequency domain data of the frame, such as by a cosine transformation of two dimensions. In the present invention, the processing module 46 can make the size of the representation value corresponding to a frame smaller than that of pixel data of the frame. Therefore, the memory 54 can store more representation value of reference frames and the comparison module 56 can compare representation value of the frames and the reference frame more rapidly.

In the prior art, advertising sections of video signals are filtered with much difficulty and thereby the user cannot manage video signals efficiently. However, the present invention detects frames having specific images among advertising sections and normal programs to assist the user in disregarding or filtering advertisements. Therefore, the present invention improves the efficiency of accessing and managing video signals.

Those skilled in the art will readily observe that numerous modifications and alterations of the device and method may be made while retaining the teachings of the invention. Accordingly, the above disclosure should be construed as limited only by the metes and bounds of the appended claims.

1. A method for detecting an advertising section within a video signal comprising:
(a) storing at least one reference frame;
(b) comparing each frame of the video signal with each reference frame and generating a result; and
(c) determining which frames of the video signal belong to the advertising section according to the result.

2. The method of claim 1 wherein when performing step (b), if a similarity of a frame of the video signal and a reference frame is greater than a predetermined similarity, the frame of the advertising section is before the frame of the video signal.

3. The method of claim 1 wherein when performing step (b), if a similarity of a frame of the video signal and a reference frame is greater than a predetermined similarity, the frame of the advertising section is after the frame of the video signal.

4. The method of claim 1 wherein step (a) comprises:
(d) broadcasting a reference video signal, the reference video signal capable of providing a plurality of frames in sequence for displaying dynamic images; and
(e) after a user assigns a frame from the reference video signal, recording the frame assigned by the user as a reference frame.

5. The method of claim 1 wherein when performing step (a), calculating representation value corresponding to each reference frame and storing the representation value, and when performing step (b), calculating representation value corresponding to each frame of the video signal and comparing the representation value of each frame of the video signal with the representation value of each reference frame for generating the result.

6. A signal processing system for detecting an advertising section within a video signal comprising:
a memory for storing at least one reference frame;
a buffer module for storing the video signal, the video signal capable of providing a plurality of frames in sequence for displaying dynamic images;
a comparison module for comparing a similarity of each frame of the video signal and each reference frame and generating a result; and
a decision module for deciding which frames of the video signal belong to the advertising section according to the result.

7. The signal processing system of claim 6 wherein if the similarity of a frame of the video signal and a reference frame is greater than a predetermined similarity, the frame of the advertising section is before the frame of the video signal.

8. The signal processing system of claim 6 wherein if the similarity of a frame of the video signal and a reference frame is greater than a predetermined similarity, the frame of the advertising section is after the frame of the video signal.

9. The signal processing system of claim 6 further comprising an interface module for receiving a frame assigned by a user from a reference video signal, the memory storing the reference frame received by the interface module.

10. The signal processing system of claim 6 further comprising a process module for calculating representation value corresponding to each frame, the memory storing the representation value for each reference frame, and the comparison module comparing the representation value of each frame of the video signal with the representation value of each reference frame for generating the result.
